(19) United States
(12) Patent Application Publication
(10) Pub. No.: US 2013/0224073 A1
(43) Pub. Date: Aug. 29, 2013

(54) Device for detection of magnetic nanoparticle aggregation or disaggregation

(71) Applicants: Karl Frank Schmidt, III, Watertown, MA (US); Gerald Lee Wolf, Newton, MA (US)

(72) Inventors: Karl Frank Schmidt, III, Watertown, MA (US); Gerald Lee Wolf, Newton, MA (US)

(21) Appl. No.: 13/681,343

(22) Filed: Nov. 19, 2012

Related U.S. Application Data
(60) Provisional application No. 61/561,897, filed on Nov. 20, 2011.

(51) Int. Cl. G01N 27/72

(52) U.S. Cl. CPC G01N 27/72
USPC 422/69

(57) ABSTRACT

A device that uses radiofrequency detection of the aggregation or disaggregation of magnetic nanoparticles without using nuclear magnetic resonance methods is described. The signals from one or more magnetic nanoparticle species in separate sample wells are compared to ascertain that aggregation or disaggregation has occurred. Depending on the specific reagents used, the detected aggregation or disaggregation event can be interpreted as an indicator of the presence of a molecule or microorganism of interest in a liquid sample.

### CROSS-REFERENCE TO RELATED APPLICATIONS

This application references provisional application No. 61/561,897.

### STATEMENT REGARDING FEDERALLY SPONSORED RESEARCH OR DEVELOPMENT

This invention is not the result or product of government sponsored research and development.

### FIELD OF THE INVENTION

This invention relates to a novel device for the detection of molecules or microorganisms in liquid samples using magnetic nanoparticle reagents without the use of Nuclear Magnetic Resonance techniques.

### BACKGROUND OF THE INVENTION

Ultrasmall superparamagnetic iron oxide (USPIO) nanoparticles are widely used for diagnostic applications both in vitro and in vivo, and, in one instance, for the treatment of iron deficiency anemia. These particles are typically less than 100 nm in size, contain 5-20 k iron atoms in a crystalline core that has a single magnetic domain, and are coated with a biologically compatible polymer (e.g. sucrose, dextran, or other synthetic carbohydrate). According to methods that exclusively use nuclear magnetic resonance (NMR) detection (see U.S. Pat. No. 7,829,350), the formation or dissociation of particle aggregates can be a surrogate indicator for various types of analyses, for example, the presence of a particular analyte or enzyme, or a chemical condition that causes aggregate formation or dissociation (e.g. pH or temperature).

Two patents (U.S. Pat. No. 516,297 & U.S. Pat. No. 7,829,350) describe methods for analyzing samples for the presence of a target molecule by detecting changes in the nuclear magnetic resonance (NMR) signal emitted by protons bound to water molecules that are in solution with the sample and the magnetic particles. This NMR based measurement is sometimes referred to as “relaxometry”. Aggregates of magnetic nanoparticles affect a reduction in the spin-spin relaxation (T2) of protons bound to water in the sample that can be observed by detecting the free induction decay (FID) emitted by the sample following excitation, and by measuring changes in the NMR parameter T2 that is calculated from the detected signals. Thus, by monitoring changes in the T2 relaxation of the sample matrix, an indirect measurement of particle aggregation or disaggregation is obtained.

U.S. Pat. No. 5,164,297 describes a method referred to as Solvent Mediated Relaxation Assay System (SMRAS) using bovine serum albumin (BSA) coated magnetic particles that react with an antibody in the presence of BSA in the sample, causing the dissociation of particle aggregates which changes the NMR signal emitted from water in the sample in a manner that allows quantitation of the concentration of BSA.

U.S. Pat. No. 7,829,350 describes a method referred to as Hybridization Relaxation Assay System (HYRAS) where the attachment of antibodies, oligonucleotides, polypeptides, and cleavable ligands to magnetic particles and subsequently detecting the formation or dissociation of particle aggregates by measuring of changes in the NMR signal emitted from water in the sample.

U.S. Pat. No. 7,564,245 describes a device that is optimally configured to perform the assay methods described in SMRAS and HYRAS, also by detecting the NMR signal emitted from water or other free protons in the sample containing the magnetic nanoparticles.

In recent years it has been observed that magnetic nanoparticles in solution exhibit a nonlinear magnetization response that can be exploited to detect the presence of the nanoparticles directly and localize the particles in three dimensional space for medical imaging applications (Gleich & Weizenecker, 2005) (US Pub. No. US 2010/0072991 A1), however, this technology has not been applied to the detection of magnetic nanoparticle aggregates for analytical applications.

An important limitation of this prior art (sp. U.S. Pat. Nos. 7,829,350 & 5,164,297 & 7,564,245) is that it indirectly measures the presence of magnetic nanoparticles and their aggregates by detecting changes in the NMR signal of the sample matrix (not the magnetic nanoparticles), leading to a high level of background signal from water molecules that are not interacting with the particles. Another limitation is the complex equipment needed to successfully conduct an NMR measurement, requiring sophisticated magnets that are often superconducting and cryogenically cooled, often requiring high current and rapidly switching power supplies for shimming the magnetic field to required homogeneity and inducing magnetic field gradients, and high frequency (>100 Mhz) electronic components (i.e. coils and amplifiers) for detection of the weak NMR signal. A simpler design that is less costly to manufacture, simpler to operate, has the potential to be miniaturized, and directly measures the characteristics of the magnetic nanoparticles is needed.

### SUMMARY OF THE INVENTION

The present invention describes a novel apparatus for the simultaneous detection magnetic nanoparticle aggregates in multiple liquid preparations (samples and controls) that indicate the presence of target molecules, pathogens, or enzymes by comparing the magnetization of fluid containing the magnetic nanoparticle reagents mixed with control reagents or samples of interest. The magnetization of the fluid is assessed by applying an oscillating external magnetic field in the presence of small receiving coils located near each of the fluid containing wells, where each well may contain a sample or a control. The apparatus allows many fluid containing wells to be measured simultaneously, and a configuration that accepts 96 well microtitre plates commonly used in laboratories is presented. By providing a direct measurement of signal generated by the magnetic nanoparticles and by using a simpler apparatus that is amenable to miniaturization for portable applications, the invention improves on prior art that accomplishes similar analyses by measuring the effects that the magnetic nanoparticles have on water molecules in the sample using complex systems needed for nuclear magnetic resonance experiments.

### DETAILED DESCRIPTION OF THE INVENTION

The present invention provides an assay apparatus for detecting the presence of an analyte, enzyme or pathogen in a liquid sample that has been combined magnetic nanoparticles without the use of nuclear magnetic resonance (NMR) and in a manner that detects signals emitted by the magnetic particles, rather than signal emitted from the sample matrix (e.g. water protons in the case of NMR). The apparatus may be used in point-of-care or laboratory settings, or configured in a portable design for field or even handheld use. The apparatus is intended to be used for the simultaneous analysis of multiple samples, and in one configuration, the apparatus is designed to accept a standard 96 well microtiter plate containing 96 individual wells for use as either samples or controls.

The apparatus measures the presence, absence, formation or dissociation of magnetic nanoparticle aggregates (clusters containing two or more nanoparticles bound together) in the fluid within the wells by measuring changes in electromagnetic radiation (radio waves) emitted by the magnetic nanoparticles in the presence of an oscillating magnetic field. Through comparison with signals from positive and negative control wells in the same magnetic field that contain and do not contain magnetic nanoparticle aggregates, respectively, the device infers the presence or absence of aggregates in the sample(s) of interest, or, in the case of time elapsed measurement, infers the formation or dissociation of magnetic nanoparticle aggregates in the sample(s) of interest.

The apparatus induces a magnetic field in the samples, causing the magnetic moments of individual nanoparticles to align with the external field. Thermodynamic agitation of the particles in solution disrupts alignment of the particles' magnetic moments with the external magnetic field leading to incomplete alignment (i.e. incomplete saturation) of all the particles' magnetic domains. Incomplete saturation is observed macroscopically as reduced net magnetization of the fluid containing the magnetic nanoparticles. When the orientation of the external field changes and the individual magnetic moments of the particles realign with it, the change in orientation of the particle's magnetic moments induce detectable voltage changes in nearby receiving coils that function like antennas. In one configuration, the external magnetic field is applied using two solenoid coils in a Hemholtz configuration where one is arranged below the sample wells and the other above the sample wells. In this and other configurations, the temperature of the samples (influencing the reactions that lead to particle aggregation or dissociation) can also be controlled by means of a thermal reservoir in which the sample plate sits.

The apparatus detects magnetic particle aggregates by detecting higher net magnetization of the fluid containing the magnetic nanoparticles caused by the interaction between the particles in individual fluid containing wells. Particle aggregates enhance the interaction between particles by reducing the distance between the magnetic cores. This particle-particle interaction facilitates the alignment of the magnetic moments with the external magnetic field leading to a higher fraction of aligned moments (i.e. higher saturation) and a higher net magnetization of the fluid than is observed in the absence of particle aggregates. By oscillating the external magnetic field at frequencies between 1 kHz and 1 Mhz, thereby causing continual realignment of the magnetic moments of the particles, the apparatus measures changes in the net magnetization of the fluid in a particular well by measuring changes in the amplitude of the voltage induced in the receiving coil that is proximal to the well. The voltage detected in the receiving coils can be analyzed for spectral power across a broad frequency range of 1 kHz to 10 Mhz or higher, given that the particles oscillate at the frequency of the external magnetic field (1 kHz-1 Mhz) and also at higher harmonics of this frequency.

Voltage induced in the receiving coil by inductive coupling between the receiving coil and the magnetic drive field can be filtered out in post data processing, for example, on a frequency basis where only the higher harmonics emitted by the magnetic nanoparticles are measured, or in another design configuration it may be compensated for electronically by using a reference coil in the same drive field that does not receive signals from any magnetic nanoparticles (e.g. an empty sample well).

This method of direct measurement of magnetic nanoparticle characteristics is an important distinction from prior art and methods based on nuclear magnetic resonance (NMR) or magnetic resonance imaging (MRI) that measure the signal emitted by protons in water molecules in the sample matrix, instead of the signal emitted by the magnetic nanoparticles themselves. Additionally, the multiplex acquisition of signals from control wells and sample wells simultaneously is an important and unique feature of this invention. By directly comparing the signal from wells containing sample combined with magnetic nanoparticle reagent with wells containing control liquids combined with nanoparticle reagent that are known to contain or not contain the molecule being detected, it is possible to correct for signal changes due to systematic effects that are unrelated to magnetic nanoparticle aggregation.

In one configuration of the device, each well is surrounded by an independent receiving coil that is connected to a dedicated control and amplification circuit. Each receiving coil is configured so as to detect signal preferentially from the fluid in the associated well, and in one design wraps around the well in one or more loops of a solenoid. In this configuration, the receiving coil is attached to a nearby tuning circuit and operational amplifier to maximize its receptivity to signals from the magnetic nanoparticles within the desired frequency range. This multi-channel configuration enables the signals to be simultaneously measured from sample wells and from wells that contain positive and negative controls for aggregate formation and/or dissociation, and the ability to make simultaneous measurements of samples as well as controls enables a definitive assessment of the formation or dissociation of magnetic nanoparticle aggregates in the sample(s) of interest by direct comparison, and also permits correction of signal artifacts (signal changes due to experimental conditions unrelated to the measurement of interest).

The magnetic nanoparticle that is used for a particular assay is prepared using standard methods to have a one or more functional ligands bound to it that confer its ability to form aggregates or dissociate from aggregated form under conditions of interest (e.g. presence of target molecule, presence of an enzyme, change in temperature, change in pH, etc.). These methods and variations thereof are described in detail in U.S. Pat. No. 7,829,350 and in other sources. In one example, particle aggregation can be used as a measure of the presence a specific analyte in a fluid sample by adding magnetic nanoparticles that have been conjugated with two species of antibodies or aptamers (oligonucleotides or polypeptides) that specifically bind two distinct moieties or epitopes on a molecule of interest (the analyte). The magnetic nanoparticles in solution will form aggregates in the presence of the analyte, but not in the absence of the analyte.

The present invention provides several improvements and distinctions over the use of NMR for the detection of magnetic nanoparticle aggregate formation or dissociation. First, the signal that is measured in the present invention originates from the magnetic nanoparticles themselves, rather than from water in the sample matrix, thereby reducing the influence of background signal received from water in the sample that is not actively interacting with the particles. Second, the effective volume of the magnetic drive field induced by the Hemholtz coils is considerably larger than the volume of homogeneous magnetic field that can be achieved for the purposes of NMR (proton resonance) measurement, the result being that a larger number of samples can be measured simultaneously using a less complicated device. Third, the electromagnetic signals detected are lower in frequency relative to many NMR based techniques, greatly simplifying the detection device and electronics.

### DESCRIPTION OF THE FIGURES

FIG. 1 is a schematic diagram of the device in an exploded view, showing the Hemholtz coils used to establish the magnetic drive field (101), the well block for holding the 96 well plate containing the samples and controls (102), the array of receiving coils, one per sample containing well (103) and the mechanical tray (104) that articulates outward to enable placement of the microtiter plate (not shown) on the well block. The user interacts with the device by using a touch sensitive display (104).

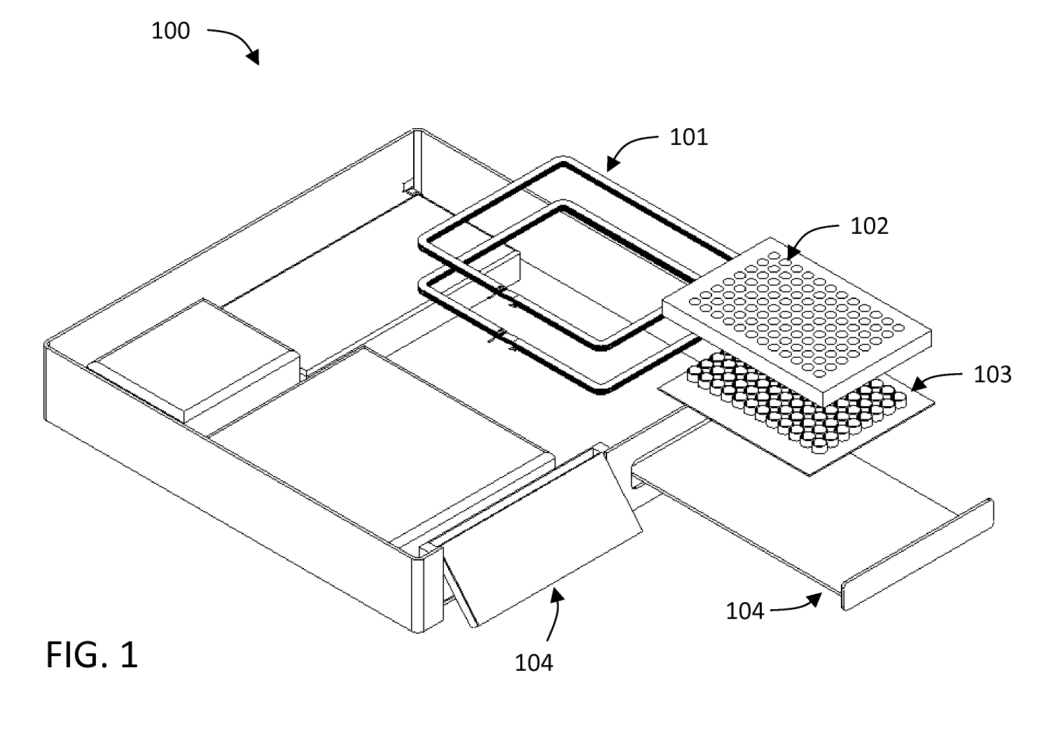

FIG. 2 is a top down view of the system, showing the location of the well block and receiver coil array (204) during analysis. During analysis, the well block is centered and located in between the Hemholtz coils (203). Electronic sub-compartments contain the power-supply (201), drive and receiving electronics (202), and computational electronics (205) for data processing and control of the user interface (206).

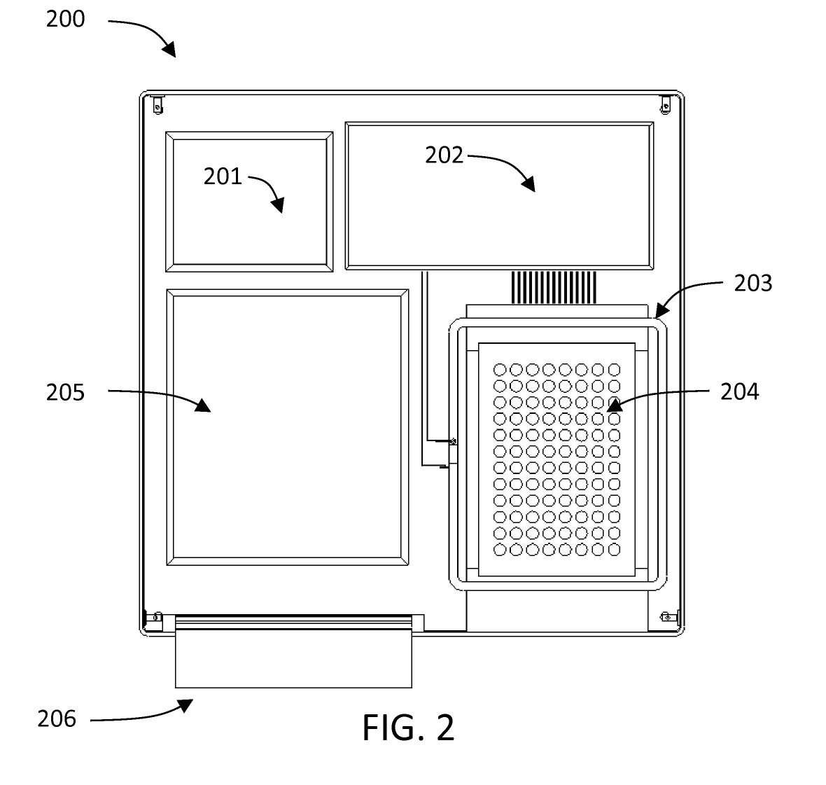

FIG. 3 is cross sectional diagram of a single sample well showing the liquid sample's (303) location in between and inside of the Hemholtz coils (301) that induce the magnetic drive field when powered by an alternating current source (302). A single receiving coil (304) surrounds the sample well and detects voltage induced by the magnetic nanoparticles (USPIOs) as the net magnetization of the sample changes in response to the drive field (302). In this example, the voltage induced in the coil is amplified by an operational amplifier (305) and the signal is post-processed to remove contributions from inductive coupling of the receive coil (304) and the drive field induced by the Hemholtz coils (301).

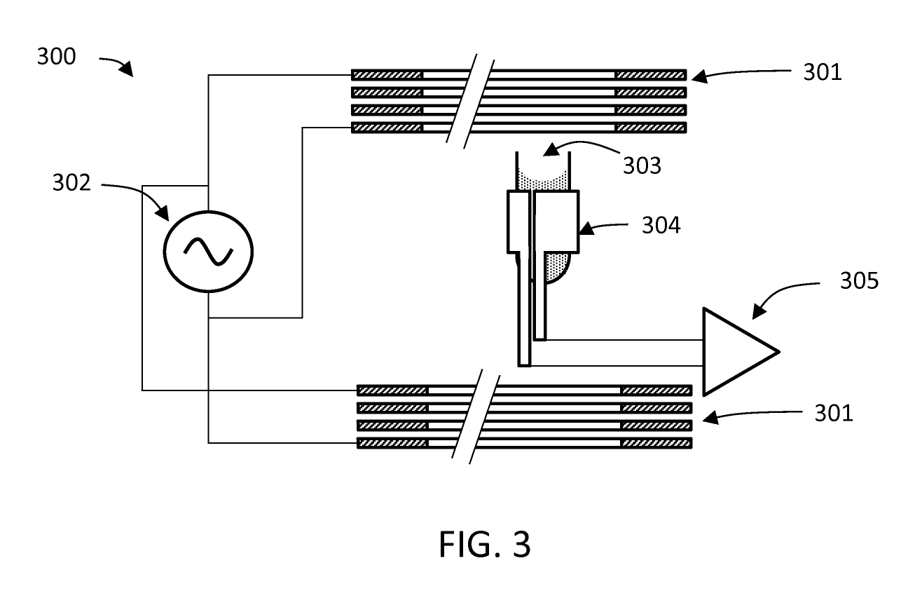

FIG. 4 is a schematic diagram of the receiving and data processing electronics required for an assay experiment. Wells containing sample combined with assay reagent (401) and control reagent (402) are measured simultaneously and changes in the voltage of the receiving coils are amplified and delivered to a signal processing unit (403) for direct comparison. Signal detected from both receiving coils oscillates at the frequency of the driving field and its higher harmonics (404) and are amplified such that the peak amplitude of oscillation is the same. After nanoparticle aggregation in the sample containing assay reagent, an increase in signal amplitude (405) relative to the well containing control reagent (406) is detected. This difference in peak amplitude of the oscillating signal can be monitored continuously over time (407) to observe trends in the signal detected from assay reagent (408) and control reagent (409) to correct for systematic errors and also increase the statistical significance of measurements inferring particle aggregation.

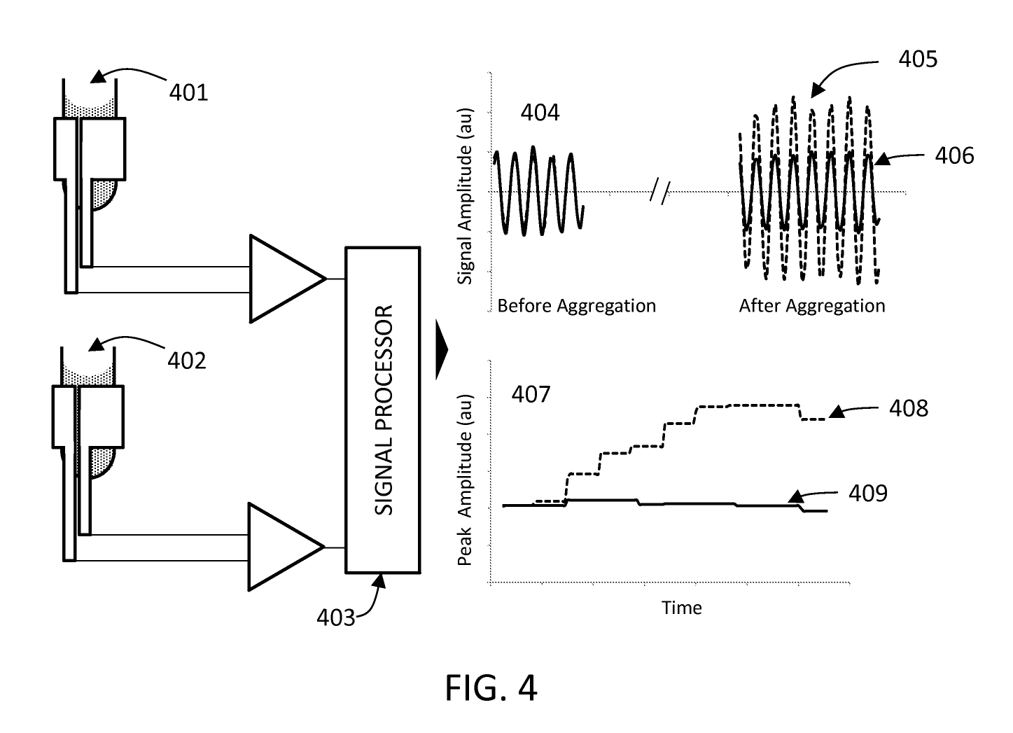

1. An assay system for determining the aggregation or disaggregation of magnetic nanoparticles, the system comprising:
a. Two or more reagents consisting of magnetic nanoparticles that bind specifically and non-covalently to a unique moiety on a target molecule or pathogen of interest and a liquid control reagent known to not contain the target molecule
b. Two or more radiofrequency transmission coils configured and controlled to induce an oscillating magnetic field in the samples with a frequency between 1 kHz and 10 Mhz
c. Two or more fluid containing wells in which the fluids containing the sample, control and magnetic nanoparticle reagents can be combined for analysis
d. Two or more radiofrequency receiving coils each located proximally to a single fluid containing well that detect voltages induced by the magnetic nanoparticles in the frequency range of 1 kHz to 10 Mhz
e. An alternating current drive circuit that powers the transmission coil in the frequency range of 1 kHz to 10 Mhz
f. A multi-channel signal detection system that amplifies and records signals emitted from the sample(s) and detected by the receiving coils
g. Data processing electronics that record and compare the signals from each receiving coil to infer the presence, absence, formation or dissociation of magnetic nanoparticle aggregates

2. The System of claim 1 where voltage from an additional coil is combined with signal from individual wells to compensate for the inductive coupling of the receiving coil to the transmission coils

3. The system of claim 1 where the magnetic nanoparticle reagents are ultrasmall superparamagnetic iron oxide (USPIO) particles, less than 150 nm in diameter
